(19) United States
(12) Patent Application Publication
(10) Pub. No.: US 2011/0175338 A1
(43) Pub. Date: Jul. 21, 2011

(54) Skateboard Propelling Assist Device

(76) Inventor: Phillip E. Senseman, Tempe, AZ (US)

(21) Appl. No.: 13/007,952

(22) Filed: Jan. 17, 2011

Related U.S. Application Data
(60) Provisional application No. 61/296,009, filed on Jan. 18, 2010.

(51) Int. Cl. A63C 11/22; B23P 11/00

(52) U.S. Cl. 280/821; 29/525.02

(57) ABSTRACT

The invention is a single pole with a flexible end, a universal gripping end, and additionally, an intermediate grip for the upper portion of the single pole. The pole alternately is connected together from shorter pieces so that its length can be shortened for storage or transport. The single pole is designed to be used by one or both hands for stability or for pushing forward on a skateboard, or similar board like surface on top of wheels.

### CROSS REFERENCE TO RELATED APPLICATIONS

This application claims the benefit of U.S. Provisional Application No. 61/296,009, filed on Jan. 18, 2010. The prior referenced application is incorporated herein by reference.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

(1) Field of the Invention

This application is directed to sporting goods and recreational activities. In particular, it is directed to methods and material objects related to skateboards for the purpose of utilizing the upper body for additionally propelling a person in motion, or alternately, for stopping purposes.

(2) Description of Related Art

Others have considered methods of propelling a person across a horizontal plane by use of twin poles. U.S. Pat. No. 5,098,087 describes and illustrates a low flatbed vehicle where the rider uses twin poles, similar to ski poles, to propel and direct motion of the rider. These poles are adapted primarily for the particular use intended, and a pair of poles are needed to be effective in steering the vehicle.

U.S. Pat. No. 5,660,401 describes a person using twin propelling poles which together are used to move a person in the forward direction on a skateboard. The use of twin poles are a distinct disadvantage for normal skateboard use, as the user must face forward to have proper use and balance of two poles. The more common and preferred method of skateboard riding is to stand sideways, that is, to have the feet generally perpendicular to the lengthwise direction of the board, which means the rider's body is mostly sideways to the motion forward. Use of twin poles in this position is impractical.

U.S. Pat. No. 3,856,321 describe a person using a wheeled board assembly, or a skiing training device, where poles are attached to the boards while the person learns at least some of the methods for snow skiing. The teachings of this disclosure do not provide for use of poles with freedom of movement.

U.S. Pat. No. 5,163,710 describes roller skating poles used similar to skiing poles for roller skating. Because the disclosure is fundamentally for roller skates, it does not consider the body position and balance needed for a person on a skateboard.

It is also desirable to have a skateboard that provides for a more general workout, such as an upper body workout. Existing skateboards are primarily a method of travel and a fun skill sporting goods device. It tends to be used by the youth, particularly young men, who find it both useful and a challenging skill test. Additional methods or equipment that would broaden its appeal to a larger or older market is particularly useful.

None of the above efforts by others consider the practical aspects of shipping, transport to site for use, or storage. The skateboard user often is very compact, that is, does not prefer long poles which might be useful for operation but are cumbersome for transport and storage. None of the references teach methods by which the poles can be shortened or made into convenient lengths for transport. Further, there is the important consideration of safety, when using a pole it is important that the pole does not collapse or break so that the user falls suddenly and receive an injury.

A single propelling and balancing pole with desirable features would be singularly helpful in making a skateboard less intimidating for those who find it a difficult means of transportation to balance when in motion. Also, a propelling pole that is useful for all common positions a skateboard rider prefers would be highly desirable from a practical viewpoint. A single pushing pole would also have the advantage that it would allow the user to push forward with only using the upper body, greatly enhancing upper body exercise. It would be very beneficial that the pole is designed to be shortened and be very safe in operation, especially when a compressive force along its length is applied.

It is also highly desirable to provide for skateboard use on a variety of surfaces, which includes off road use. That is, use on terrain such as grass, gravel, and dirt which may or may not be smooth.

### BRIEF SUMMARY OF THE INVENTION

The invention is a single pole with a round elastomer end, a universal gripping end, and additionally, an intermediate grip for the upper portion of the single pole. The pole alternately is telescopic or connected together by interlocking screws so that its length can be shortened for storage or transport. The single pole is designed to be used by one or both hands for stability or for pushing forward on a skateboard, or similar board like surface on top of wheels.

### BRIEF DESCRIPTION OF THE SEVERAL VIEWS OF THE DRAWING(S)

FIG. 1 shows one embodiment of the present invention.

FIG. 2 shows another embodiment of the present invention where the pole can be disassembled into two parts by a threaded connection.

FIGS. 3A and 3B show how the ground tip is attached to the pole in one embodiment.

FIG. 4 shows different ground tips and texture patters on end tips.

### DETAILED DESCRIPTION OF THE INVENTION

The single pole invention is useful for a skateboard rider for three principle operations. A rider can use a pole for balancing, slowing, or propelling in a direction. The motion generated by the pole is primarily initiated by arms and hands, as well as the upper body. The lower body and legs are generally used for additional stability and balancing while using the single pole, although, there is some additional force generated if the entire body is used while using the single pole.

The single pole is normally planted firmly on the ground and then the skateboard rider presses at least some downward force through the lengthwise direction of the pole to hold it in place on the ground. The rider then preferably uses both hands in a somewhat pivoting motion to sweep the ground behind the rider in order to propel forward. If the rider desires to stop, the rider can plant the end of the single pole into the ground and apply a force to which allows the pole end to approach the moving skateboard, or the rider may simply allow the end of the pole to slide along the ground for a moderate braking action.

The pole is preferably simply designed, and utilizes hand grips which allow the skateboard rider to easily switch sides of the skateboard without having to rotate the pole in order to find a correct orientation to hold it properly. It is not desirable, from a rider standpoint, to have a particular hand grip which requires the pole to be oriented to a particular rotation relative to the rider, in order for the hand grip to be properly held. It is highly desirable that the handgrip is more universal from a rotational standpoint about its lengthwise axis, and allows for convenient switching from side to side so that the motion of the rider on the skateboard is clean and elegant, and has a smooth, natural rhythm to it.

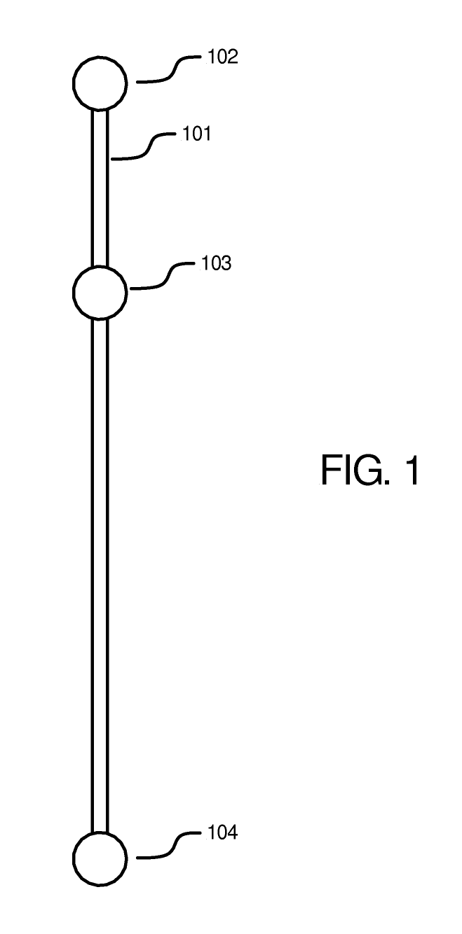

FIG. 1 shows one embodiment of the present invention which is a lengthwise assembly of a number of parts. A pole 101 (i.e. a wooden pole for example) generally comprising a long slender element such as a tube, rod, or pipe has a spherical end grip 102, an optional intermediate hand grip 103, and a lower flexible ground tip 104. The tube is made from a suitable material that includes heat treated aluminum, fiberglass, a composite, or stainless steel. The ground tip 104 is made from a flexible material that is tough, resists cutting, and is able to withstand abrasion and the forces of use with minimal maintenance. Suitable materials include rubber, neoprene, and plastics that are modified to be flexible and have a high durometer. It is connected by methods such as glue or screws, or similar hardware. In one embodiment of the present invention, the rider wears gloves to prevent the development of hand blisters from the end grip 102 and intermediate hand grip 103. The end grip 102 and hand grip 103 are made from a suitable material that includes rigid materials such as plastics, wood, and metal. Alternately, the end grip 102 and the hand grip 103 are made from flexible material. Alternately, the end grip 102 and the hand grip 103 are made from the same material as the ground tip 104.

The hand grip 103 is attachable to the pole by an interference fit, or alternately, by use of an adhesive. The use of a lubricant on the pole is helpful for sliding it into the proper or desirable location. It is desirable to connect the hand grip 103 at the convenient position for rider preference.

The pole has a uniform diameter, or alternately a diameter that varies, depending upon the desired weight, force design, and atheistic appeal. The pole is either hollow or solid. It is highly desirable to decorate the pole with various exterior paints, enamels, films, decals, logos, and labels such as might be preferred for a rider. Alternatively, the pole includes reflective tape to improve safety when used during twilight or night. The pole is preferably made from metal, hard plastic, fiberglass, wood, or a composite.

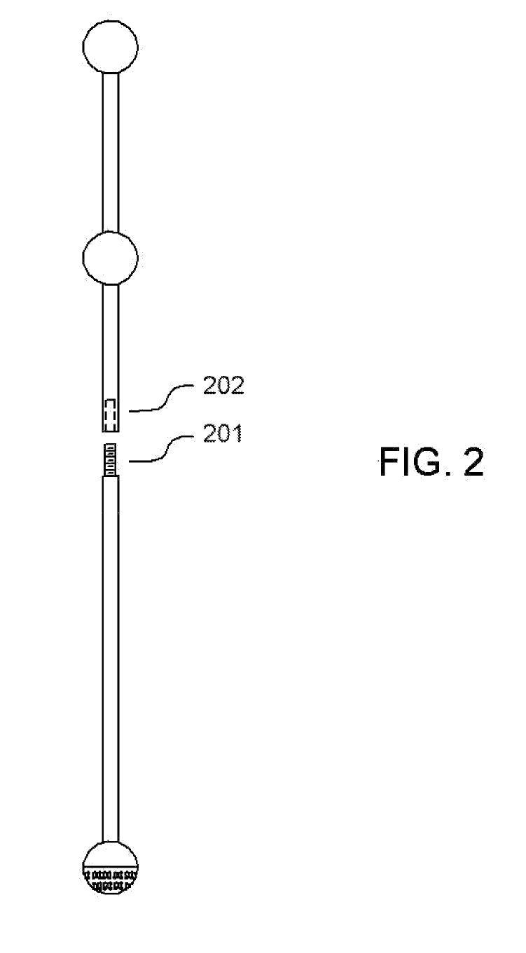

FIG. 2 shows another embodiment of the present invention where the pole is disassembled into two parts by a threaded connection. The lengthwise assembly of the pole is similar to the one illustrated in FIG. 1, and shows a male thread 201 and a female thread 202. Though not shown, the elongated pole is alternately reduced to a number of lengths, as short as desirable by the user, such as 3 to 6 pieces. A larger number of pieces is desirable in some cases, such as for transportation in a backpack, for example.

Alternately, to the design shown in FIG. 2, the pole is designed to be telescopic. A suitable method needs to be included to assure that the pole does not shorten when the rider places a force on it, to ensure that the rider does not fall and receive an injury. A spring loaded pop out pin mechanism is used, for example, to prevent this. A cam lever which activates a ring clamp is alternately used.

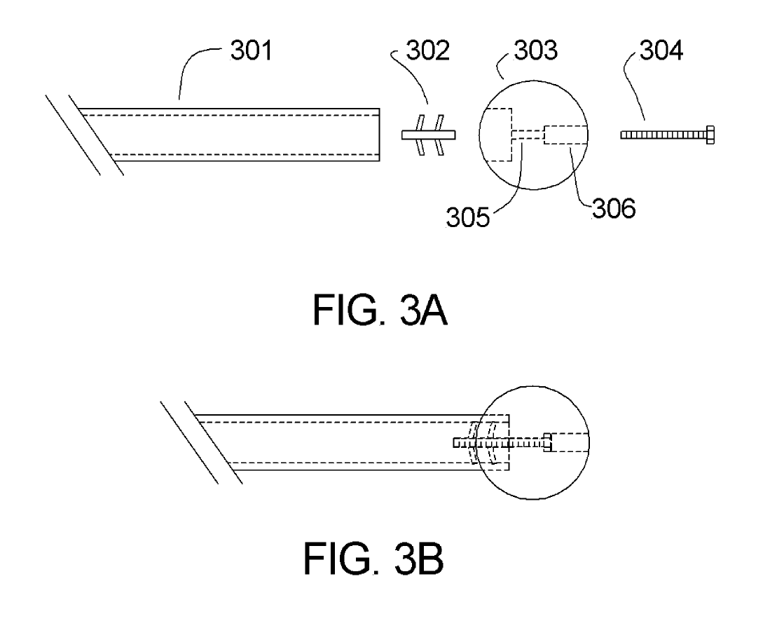

FIG. 3A shows how the end or ground tip is attached to the pole, if the pole is a tube 301, by use of a star nut 302, a sphere 303, and a through bolt 304. The bolt 304 threads into the center star nut which has female threads. The sphere has a predrilled through hole 305 and a recessed countersink 306 for the through bolt 304. The final assembly is shown in FIG. 3B. A special tool is used to insert the star nut inside the tube to assure it properly grips the inside surface of the tube 301. The star nut outer projecting tabs are designed to firmly grip the inside of the tube with a suitable force to allow the bolt to develop the necessary torque that attaches the sphere. Other methods could be used to attach the sphere 303 to the end tube, such as molding a bolt into the sphere and threading it into a molded female connection at the end of the tube, or alternately, bonding the sphere onto the tube with a bonding adhesive such as glue.

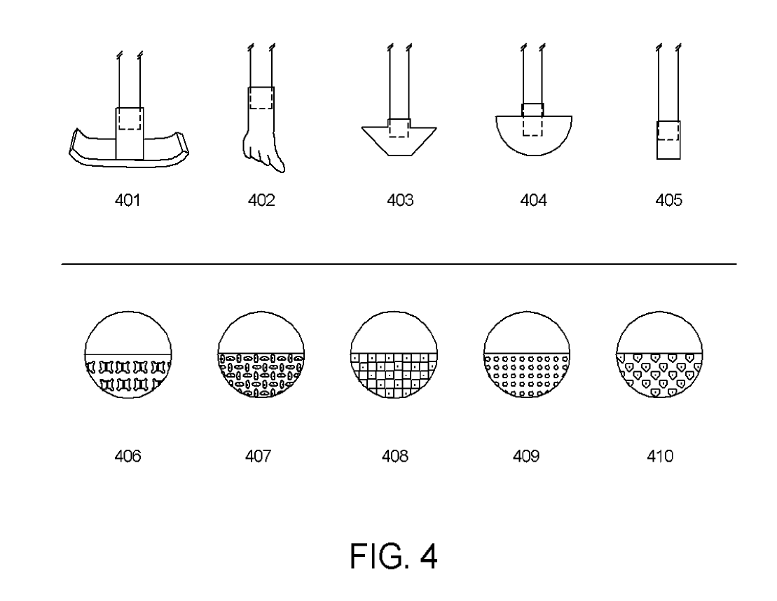

FIG. 4 shows various patterns that can be added to the ground tip to improve gripping when the rider skates on various terrain that may not be concrete or asphalt. Off road surfaces such as dirt roads, paths, grass, gravel, and other non smooth surfaces are attractive places to skate for a rider, and the gripping power of the pole is improved if a different pattern on the ground tip is used. Various geometrical end tips are shown in 401-405, and various texture patterns for a sphere are shown in 406-410. These are meant to be illustrative only, and not exhaustive.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

I claim:

1. An assisting pole for use with a skateboard comprising:
a. a lengthwise assembly comprising a plurality of elongated slender elements,
b. an end flexible tip,
c. wherein said end flexible tip is connected to a first end of said lengthwise assembly,
d. an end spherical holding grip,
e. wherein said end spherical holding grip is connected to a second end of said lengthwise assembly,
f. an intermediate spherical holding grip,
g. wherein said intermediate spherical holding grip is connected to said lengthwise assembly between said first end and said second end, and
h. wherein said end spherical holding grip and said intermediate spherical holding grip are useful to hold said lengthwise assembly by a rider upon said skateboard,
whereby said assisting pole is used to propel, slow, or balance said rider on said skateboard.

2. An assisting pole according to claim 1 wherein said lengthwise assembly incorporates at least two said elongated slender elements connected by a screw connection.

3. An assisting pole according to claim 1 wherein said lengthwise assembly incorporates at least two said elongated slender elements connected by a telescopic connection.

4. An assisting pole according to claim 1 wherein any said elongated slender element is made from a tube, pipe, or a rod.

5. An assisting pole according to claim 1 wherein any said elongated slender element is primarily made from metal, plastic, fiberglass, wood, or a composite.

6. An assisting pole according to claim 1 wherein any said elongated slender element has a non uniform diameter along its length.

7. An assisting pole according to claim 1 wherein said end flexible tip is connected to said lengthwise assembly by use of a screw or bonding adhesive.

8. An assisting pole according to claim 1 wherein said end flexible tip has a textured pattern.

9. An assisting pole according to claim 1 wherein said skateboard is used on dirt roads, paths, grass, gravel, or other off road surfaces.

10. An assisting pole for use with a skateboard comprising:
a. an elongated slender element,
b. an end flexible tip,
c. wherein said end flexible tip is connected to a first end of said elongated slender element,
d. an end spherical holding grip,
e. wherein said end spherical holding grip is connected to a second end of said elongated slender element,
f. an intermediate spherical holding grip,
g. wherein said intermediate spherical holding grip is connected to said elongated slender element between said first end and said second end, and
h. wherein said end spherical holding grip and said intermediate spherical holding grip are useful to hold said elongated slender element by a rider upon said skateboard,
whereby said assisting pole is used to propel, slow, or balance said rider on said skateboard.

11. An assisting pole according to claim 10 wherein said elongated slender element is made from a tube, pipe, or a rod.

12. An assisting pole according to claim 10 wherein said elongated slender element is primarily made from metal, plastic, fiberglass, wood, or a composite.

13. An assisting pole according to claim 10 wherein said elongated slender element has a non uniform diameter along its length.

14. An assisting pole according to claim 10 wherein said end flexible tip is connected to said elongated slender element by use of a screw or bonding adhesive.

15. An assisting pole according to claim 10 wherein said end flexible tip has a textured pattern.

16. An assisting pole according to claim 10 wherein said skateboard is used on dirt roads, paths, grass, gravel, or other off road surfaces.

17. A method of attaching an flexible end sphere to a tube comprising:
a. a star nut,
b. wherein said star nut incorporates a center female threaded connection,
c. wherein said star nut is pressed into an end of said tube,
d. wherein said star nut incorporates external tabs useful for attaching the star nut to the inside surface of a tube,
e. an attaching bolt with male threads that substantially match said center female threaded connection, and
f. wherein said flexible end sphere has a through hole suitable for inserting said attaching bolt, and
g. wherein said flexible end sphere is attached to said tube by use of said attaching bolt inside said through hole threaded into said star nut which is inside said tube.

18. A method of attaching a flexible end sphere to a tube according to claim 17 wherein said flexible end sphere additionally contains recessed machining so that said attaching bolt is completely inside the outer perimeter of said flexible end sphere when said attaching bolt is tightened.
